(19) United States
(12) Patent Application Publication
(10) Pub. No.: US 2009/0171509 A1
(43) Pub. Date: Jul. 2, 2009

(54) Electric Power Flow Control

(75) Inventors: Sture Lindahl, Lund (SE); Juhani Mantere, Tuusula (FI); Lars Gertmar, Västerås (SE); Hans Christian Christensen, Copenhagen (DK); Erik Kolby-Nielsen, Odense (DK); Leif-Erik Wraae, Tommerup (DK)

Correspondence Address: VENABLE LLP, P.O. BOX 34385, WASHINGTON, DC, 20043-9998, US

(73) Assignee: ABB RESEARCH LTD., Zürich (CH)

(21) Appl. No.: 11/794,317

(22) PCT Filed: Dec. 27, 2004
(86) PCT No.: PCT/SE2004/002037

§ 371 Date: May 28, 2008

(51) Int. Cl. G06F 1/28; H02J 3/38

(52) U.S. Cl. 700/292; 307/80

(57) ABSTRACT

A farm including a plurality of electric power generation units connected to a grid point of a power network. The power generation units are organized in a plurality of upstream branches. Each upstream branch is separable from an adjacent downstream branch by an interrupter.

### TECHNICAL FIELD

The present invention concerns power flow control of a plurality of electric power generating units. The generating units are organized in branches and sub-branches to deliver electric power to a grid point of a power network. An upstream branch is disconnectable by a current interrupter from a downstream branch. The plurality of electric power generating units may be assembled in a farm or a cluster in a distant location from the power network. By the expressions upstream and downstream is meant the direction from the generator to the grid point.

By the expression current interrupter, which in the following text is denoted interrupter, should be understood any means for stopping the power flow. Thus, an interrupter comprises a switchgear, a load breaker, a circuit breaker, a contactor, a mechanical switch and such.

### BACKGROUND OF THE INVENTION

Electric power generating units are often organized in a plurality of upstream branches in a farm which is connected to a grid point of a power distribution network or a power transmission network. The electric power generating units may be organized as dispersed energy resources and may be connected to a plurality of grid points. Especially offshore or desert windmill farms are organized in such a way. All upstream branches must be disconnectable from a downstream branch or from the grid point if a fault occur somewhere in the farm. Every time a branch is disconnected the delivery of electric power to the grid point decreases. Then the network owner or the farm operator has to decide if an auxiliary electric generation capacity must be connected to the network in order to compensate for the decreased capacity of the windmill farm. Early information of such a sudden capacity decrease in power generation is of high desire for the network owner or the farm operator.

In a windmill farm the windmills are organized in upstream branches from the grid point. When a fault occurs in an upstream branch, the fault containing branch is disconnected from the downstream branch. The power generation capacity thus immediately decreases by the number of windmills that are disconnected. Not only the windmills that are connected to the fault containing branch will be disconnected but also all windmills that are connected to any upstream branches connected to the fault containing branch. The decrease in power delivery to the grid point of the network is sudden and the network owner or the farm operator must in this situation request for an auxiliary power generation capacity. To start up an auxiliary power generation on such a short notice is very difficult. In order to have such auxiliary power generation capacity available at any time a whole power generation plant must be held in a standby position at all times.

A windmill comprises a mechanical part and a generator part connected with a common shaft. The mechanical part comprises a wind turbine having a turbine rotor connected to the common shaft. The mechanical part may also comprise a gearbox. The turbine rotor contains a plurality of blades, whose angles towards the wind are adjustable to achieve a shaft speed/torque of desire. In large windmills the wind turbine is very heavy and the rotor with the rotor blades possesses besides the weight a great moment of inertia. Thus, a turbine rotor cannot be stopped spontaneously. Instead, in case of a sudden order to stop generating power, the turbine rotor will continue to rotate, at least for a short period of time, and thus continuously introduce rotation to the common shaft. The generator part comprises a stator and a rotor connected to the common shaft. The generator also comprises rotor windings and stator windings.

When a plurality of windmills is suddenly disconnected from a downstream branch they will continue to deliver electric power. But in such a situation there is no power consumer on the line but only producers. When thus all windmills on the isolated circuit continue to produce electric power the power has to go somewhere. In a first moment of time the voltage will rise. In a next period of time one of the windmills will be forced to become an electric motor and thus consume the electric power produced by the others. This weak windmill now has two energy sources. The wind will force the wind turbine to continue to rotate the common shaft. And the generator now turned into an electric motor will also put rotational energy into the common shaft. In this situation the speed of the turbine rotor will increase in an uncontrolled way. The result will be either a mechanical breakdown or the generator will burn.

### SUMMARY OF THE INVENTION

A primary object of the present invention is to provide a power flow control for the electric power generating units in a farm comprising a plurality of electric power generating units. The system should also protect the generators in case of fault occurrences. A secondary object of the invention is to rapidly reorganize the generators in order to minimize the loss of electric power delivery capacity of the farm.

This object is achieved according to the invention by a farm of electric power generating units characterized by the features in the independent claim 1, by a method characterized by the steps in the independent claim 5, or by an electric power facility characterized by the features in the independent claim 11. Preferred embodiments are described in the dependent claims.

According to the invention the signal to open an interrupter is sent to every upstream generator control unit. The order signal to open the contacts is always sent before the real opening of the contacts is effected. Depending on the size and characteristics of the interrupter there is a pre-process time period in the range of 10 to 500 ms before the interruption is achieved. By sending the order signal to an upstream generator control unit the generator control is capable of neutralizing the generation and put the generator in a standby position. A standby position is when the airgap of the generator is demagnetized to a low torque level and the generator is still rotating. Thus, in the standby position the generator does not produce any energy but stays synchronized with the electric system. The procedure may well be accomplished during the pre-process time period of the interrupter. This means that when the contacts begins to open all upstream generators are in a standby position and thus do not produce any power passing the interrupter. This affects the working condition of the interrupter which only has to open a circuit with a very small power flow.

When the branch containing the fault and all upstream branches are disconnected a main farm controller containing computer means, memory means and program means is localizing the fault and reorganize the generators. When the main controller has decided which of the generators that must be stopped the downstream interrupter of these generators receives an open command to isolate the fault and the isolated generator control receives a stop command. The other generators that thus still are connectable will receive an order to continue to generate once the downstream interrupter is closed again.

According to a first aspect of the invention the objects are achieved by a farm of electric generators organized in upstream branches, each branch being disconnectable from a downstream branch, wherein every generator comprises a control unit that on receiving an open order signal from a downstream interrupter puts the generator in a standby position.

According to a second aspect of the invention the objects are achieved by a method for minimizing the influence of a fault in the farm, comprising, sending from an interrupter upon sensing a fault condition the opening order signal to every upstream generator control, and putting on receiving the opening order signal each generator in a standby position. In a further embodiment the generator connections are rearranged by opening interrupters to isolate the branch containing the fault. In a further embodiment a stop order is sent to the isolated generators, a continue order is sent to the remaining generators and the open interrupter is closed.

A fault condition may also occur when an operator manually opens the interrupter without the upstream generators having been shot dawn. A fault condition also includes an opening order to an interrupter from a surveying system. Thus, as soon as the interrupter senses that someone is opening the interrupter manually, that interrupter sends an open order signal to every upstream generator.

### BRIEF DESCRIPTION OF THE DRAWINGS

Other features and advantages of the present invention will become more apparent to a person skilled in the art from the following detailed description in conjunction with the appended drawings in which:

FIG. 1 is a single line diagram of a part of a windmill farm, and

FIG. 2 is windmill according to the invention.

### DESCRIPTION OF PREFERRED EMBODIMENTS

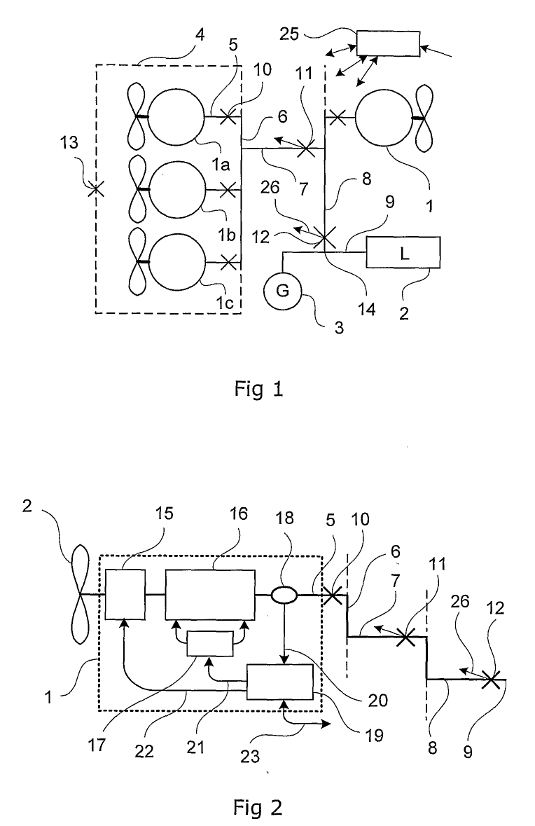

An example of a windmill farm according to the invention is shown in FIG. 1. A plurality of windmills 1 are connected in branches organized in an upstream pattern. The whole farm is finally connected to a grid point 14 of a network 9 for distribution or transmission of electric power to a consumer 2. In the figure three windmills are connected to a most upstream branch 6, which in the embodiment shown may have a ring connection 4 operated by an ring connection interrupter 13. Every windmill is connected to each branch with a first connection line 5, which comprises a first interrupter 10.

The most upstream branch 6 is in the example connected to a least upstream branch 8 with a second connection line 7 which comprises a second interrupter 11. As indicated by the windmill 1 on the left side of the figure, a plurality of windmills may be connected directly or by other upstream branches to the least upstream branch 8. Finally the least upstream branch is connected to the grid point 14 via a third interrupter 12. All interrupters have a communication link 26 that receives and sends information. On the network 9 there are other electric power generation capabilities 3. The windmill farm also comprises a main controller 25 for supervising the activity of the power generation from the farm. The main controller comprises a communication link which receives and sends information to all units in the farm as well as to the network owner or the farm operator. This is shown in the figure by a plurality of arrows indicating the information links.

The windmill farm in FIG. 1 is shown by way of example. Thus, the farm may have any number of branches organized in an upstream pattern. Although not shown in the figure the farm may comprise a plurality of interrupters and disconnectors that make possible to organize and reconnect the windmills to any configuration of desire.

A windmill unit according to the invention and its connection to the grid point is shown in FIG. 2. The windmill 1 comprises a turbine 2 having a turbine rotor with a plurality of turbine blades. Further the windmill comprises a mechanical unit 15. The mechanical unit comprises an optional gearbox and control facilities for controlling the pitch of the blades as well as a system for braking the turbine rotor. Further the windmill comprises an electric rotating machine 16 having a rotor connected to the mechanical unit and a stationary stator. The electric rotating machine also comprises a rotor winding and a stator winding and a converter 17 for regulating the electric rotating machine.

According to the invention the windmill further comprises a control unit 19 for controlling the performance of the windmill. The control unit receives information 20 from a sensing unit 18 on the connection line 5. The control unit receives information about current, voltage, power generated and efficiency. Normally the control unit is arranged to control the windmill for the best performance available. The control unit has a first control line 21 for controlling the converter 17 and a second control line 22 for controlling the mechanical equipment 15. The control unit also comprises a communication link 23 for exchange of information with the main controller and other units in the farm. The windmill unit may also comprise internal interrupters or disconnectors for controlling the power flow within the unit.

As described in conjunction with FIG. 1 the windmill is connected to a most upstream branch 6 via a first connection line 5 having a first interrupter 10. The most upstream branch is connected to the least upstream branch 8 with a second connection line 7 having a second interrupter 11. Finally the least upstream branch 8 is connected to the grid point 9 via a third interrupter 12. Each interrupter comprises a communication link 26 for exchange of information.

On detecting a fault condition in the farm the closest downstream interrupter will disconnect the branch having the fault condition and any upstream branches connected to the fault containing branch. An opening order is received by the interrupter actuator either from sensing a fault, receiving a signal from the main controller, or from a manual opening sensing device. Each interrupter comprises a communication link 26 that will send each such opening order signal transparently to every upstream windmill. By the expression transparently should be understood immediately or as soon as possible. This communication is shown in the figure by an arrow from the interrupter. The communication link comprises in one embodiment a cordless system. In another embodiment the communication link comprises an optical fiber. In yet another embodiment the communication link comprises a data communication system.

Assuming that a fault condition appears in the most upstream branch 6 the second interrupter 11 will receive an opening order signal. On receiving the opening order signal the interrupter communication link 26 immediately sends the signal further to every downstream windmill and then starts its opening process. The opening process includes finding a next current zero crossing, synchronizing the operation and performing the opening operation. Simultaneously the control unit of each upstream windmill receives the opening order signal. On receiving the opening order signal through the information link 23 the windmill control unit 19 will control the windmill to assume a standby position. By the time the interrupter has achieved the opening state, every upstream windmill has assumed the standby position. Thus the interrupter does not have to perform a breaking operation but only a disconnection operation.

The simultaneous operation of the interrupter and the windmill control unit not only has the advantage of reducing the stress on the interrupter but also put the isolated branch in non generating state. In the isolated branch there is thus no current flow. This makes possible to reorganize the isolated windmills to open a strategically positioned disconnector to isolate the fault. When the reorganization is accomplished the main controller sends a stop order to the still isolated windmills. Then a closing signal is sent to the open interrupter as well as a continue order to all the reorganized windmills that is connected and capable of generating electric power.

By putting the windmill in a standby position the next operation whether it being a stop order or a continue order is easy to accomplish. This is advantageous since a start from a stop position is both complicated and time consuming.

Although favorable the scope of the invention must not be limited by the embodiments presented but contain also embodiments obvious to a person skilled in the art. The windmills that are shown by way of example may comprise any kind of electric energy producing apparatus organized in upstream branches. In fact any cluster of electric units connected to a grid point of a power network and organized in upstream or downstream branches belongs to the scope of the invention. Also the cluster may comprise any number of interrupters or disconnectors for controlling the power flow.

1. A farm, comprising:
a plurality of electric power generation units connected to a grid point of a power network, wherein the power generation units are organized in a plurality of upstream branches, each upstream branch being separable from an adjacent downstream branch by an interrupter, wherein each interrupter comprises a communication link for transparently sending an opening order to all upstream electric power generation units, and wherein each electric power generation unit comprises a control unit with a communication link for receiving the opening order from a downstream interrupter, whereby the control unit upon receiving a opening order puts the electric power generation unit in a standby position.

2. The farm according to claim 1, further comprising:
a main controller comprising computer means for localizing the fault condition and for reorganizing the electric power generation units after the fault has been isolated.

3. The farm according the claim 1, further comprising:
disconnectors to isolate every electric power generation unit.

4. The farm according to claim 1, wherein the generator comprises a converter which on receiving a control signal from the control unit assume a standby position, a stop position or a continue position.

5. A method for controlling a farm of electric power generation units connected to a grid point of a power network, the method comprising:
sending from an interrupter upon sensing a fault condition an opening order signal to every upstream generator control unit, and
putting each electric power generation unit on receiving the opening order signal in a standby position.

6. The method according to claim 5, further comprising:
isolating the branch or generator unit containing the fault,
rearranging the generator connections, and
sending a stop order to the isolated generator units.

7. The method according to claim 6, further comprising:
sending a continue order to the remaining generators, and
closing the open interrupter.

8. A computer program product, comprising:
a computer readable medium; and
computer program instructions recorded on the computer readable medium and executable by a processor for carrying out a method for controlling a farm of electric power generation units connected to a grid point of a power network, the method comprising sending from an interrupter upon sensing a fault condition an opening order signal to every upstream generator control unit, and putting each electric power generation unit on receiving the opening order signal in a standby position.

9. The computer program product according to claim 8, wherein the computer program instructions are further for providing the computer program instructions at least in part over a network.

10. The computer program product according to claim 9, wherein the network is the internet.

11. An electric power production facility, comprising:
an electric power generation unit connected to a power network and comprising a control unit with a communication link; and
an interrupter connected to a power network and comprising a communication link for transparently sending an opening order to the electric power generation unit, wherein the communication link receives the opening order from a downstream interrupter, whereby the control unit upon receiving a opening order puts the electric power generation unit in a standby position.
